(19) United States
(12) Patent Application Publication
(10) Pub. No.: US 2010/0066841 A1
(43) Pub. Date: Mar. 18, 2010

(54) METHOD AND APPARATUS FOR RECORDING AND VIEWING OF AN AUDIO/VIDEO PROGRAM IN RESPONSE TO A NON-RECORDING EVENT DURING THE PROGRAM

(76) Inventor: Gavin Quail, (US)

Correspondence Address: SETTER ROCHE LLP, PO BOX 780, ERIE, CO, 80516, US

(21) Appl. No.: 12/210,831

(22) Filed: Sep. 15, 2008

(51) Int. Cl. H04N 5/225

(52) U.S. Cl. 348/207.11; 348/E05.042

(57) ABSTRACT

A method for operating an audio/video recording device is presented. In the method, an audio/video program is delivered to an output device for display. An indication of an event not associated with a recording function of the audio/video recording device is received during delivery of the audio/video program. In response to receiving the indication, a current location within the audio/video program is marked, and the audio/video program is recorded if the program was not recorded previously. The recording of the audio/video program is delivered to the output device beginning at the marked location in the audio/video program.

### BACKGROUND

With the advent of digital video recorder (DVR) technology, viewers of audio/video programming have enjoyed the ability to quickly and easily record hours of programs of their choosing onto a hard disk drive without the problems inherent in the use of removable storage media, such as video cassette tape. A DVR is often implemented as a standalone device or as an integrated component of a satellite or cable set-top box (STB).

User interaction is often required to enjoy the benefits of the DVR. For example, to record a program currently being broadcast for later viewing, the viewer may immediately initiate the recording of the current program by way of a recording command normally instigated by way of a remote control device associated with the DVR. To record a program to be broadcast at a future time or date, the viewer typically employs a recording timer incorporated in the DVR to initiate and terminate recording of the program at a predetermined day and time. Oftentimes, the viewer may directly set the starting and ending times of the recording, or merely select the program to be recorded from a stored electronic program guide (EPG) accessible to the DVR.

In some cases, the DVR may also record or buffer the most recent portion of a program currently being viewed up to some maximum amount of time to allow the viewer to replay a portion of the program already shown. Such capability is typically available to the user for any program currently being viewed without the user specifically requesting such buffering.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIG. 1 is a block diagram of an entertainment system including an audio/video recording device according to an embodiment of the invention.

FIG. 2 is a flow diagram of a method according to an embodiment of the invention for operating the audio/video recording device of FIG. 1.

FIG. 3 is a block diagram of an audio/video recording device according to an embodiment of the invention.

FIG. 4 is a flow diagram of a method according to an embodiment of the invention for operation the audio/video recording device of FIG. 3.

FIG. 5A is a graphical representation of the delivery and recording progress of an audio/video program according to an embodiment of the invention in which delivery of the program is not paused.

FIG. 5B is a graphical representation of the delivery and recording progress of an audio/video program according to an embodiment of the invention in which delivery of the program is paused.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

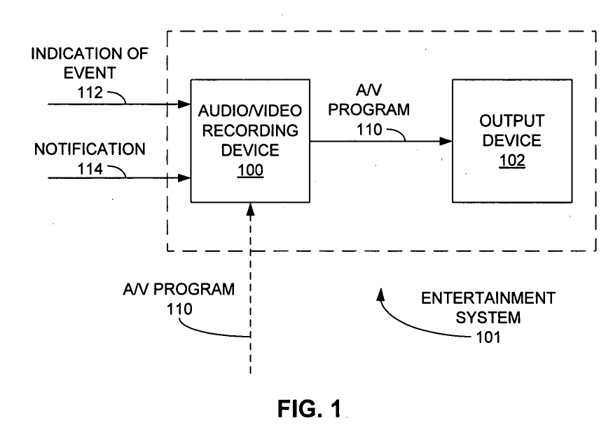

FIG. 1 is a simplified depiction of an entertainment system 101 including an audio/video recording device 100 according to an embodiment of the invention. Examples of the audio/video recording device 100 include, but are not limited to, television set-top boxes for satellite, cable, and terrestrial broadcast systems; terrestrial, cable, and satellite radio receivers; digital video recorders (DVR) units; and computer systems, as well as any other device capable of recording audio/video programming, and presenting the audio/video programming for display to a user. The audio/video recording device 100 is coupled with an output device 102, such as a television, video monitor, audio receiver, or the like. While the output device 102 is displayed as being physically separate from the audio/video recording device 100, the two components 100, 102 may be integrated as a single system, such as in a desktop or laptop computer. In the context of the embodiments discussed herein, the term “audio/video” may refer to video and associated audio, video only, or audio only.

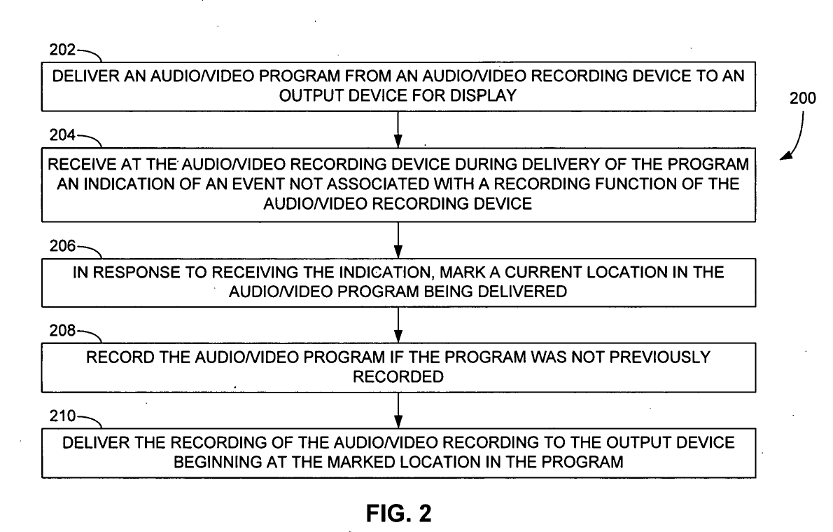

FIG. 2 provides a flow diagram of a method 200 for operating the audio/video recording device 100 of FIG. 1. However, the method 200 may be employed on other similar devices not specifically described herein.

In the method 200, the audio/video recording device 100 delivers an audio/video program 110 to the output device 102 for display (operation 202). The audio/video program 110 may be any quantity of audio and/or video intended to be presented as a contiguous segment to a user. For example, the audio/video program 110 may include, but is not limited to, a motion picture, a news program, an episode of a drama or comedy series, or a sporting event. The audio/video recording device 100 may receive the audio/video program 110 from another source, with the audio/video program 110 possibly taking a form different from that being delivered to the output device 102. In another implementation, the audio/video recording device 100 may generate the audio/video program 110 from other data by the recording device 100.

The audio/video recording device 100 also receives an indication 112 of an event not associated with a recording function of the audio/video recording device 100 during the delivery of the audio/video program 110 (operation 204). For example, the event may be any event not directly related to the recording of the audio/video program 110. In response to receiving the indication 112, the audio/video recording device 100 marks a current location in the audio/video program 110 being delivered (operation 206) and records the audio/video program 110 if the program 110 was not recorded previously (operation 208). The audio/video recording device 100 delivers the recording of the audio/video program 110 to the output device 102 beginning at the marked location in the audio/video program 110 (operation 210). While FIG. 2 indicates a specific order of execution of the operations 202-210, other possible orders of execution, including concurrent execution of one or more operations 202-210, may be undertaken in other implementations. In another embodiment, a computer-readable storage medium may have encoded thereon instructions for a processor to direct the audio/video recording device 100 to implement the method 200.

Based on the foregoing, use of one or more of the embodiments described herein may prevent a user from inadvertently missing a portion of an audio/video program being viewed due to an interruptive event, such as a phone call, e-mail message, or the like, while the audio/video program is being presented to the user for viewing.

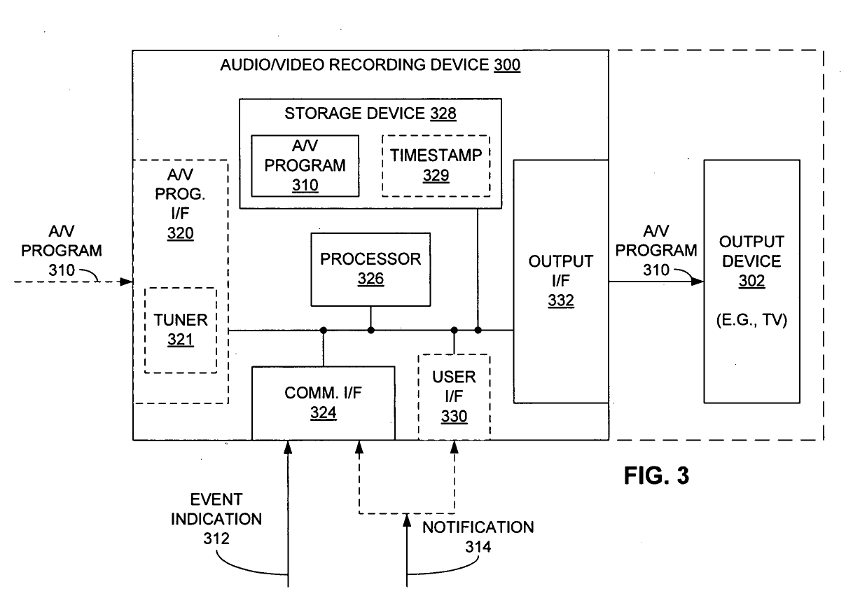

FIG. 3 provides a block diagram of an audio/video recording device 300 according to another embodiment of the invention. The audio/video recording device 300 includes at least a communication interface 324, a storage device 328, an output interface 332, and a processor 326. Optionally, the audio/video device 300 may also incorporate an audio/video programming interface 320 and a user interface 330, along with other components not specifically mentioned or discussed below. Each of these components is described in greater detail hereinafter.

As with the audio/video recording device 100 of FIG. 1, examples of the audio/video recording device 300 of FIG. 3 include, but are not limited to, satellite, cable and terrestrial television set-top boxes; terrestrial, cable, and satellite radio receivers; digital video recorders (DVRs); and computer systems, as well as any other device capable of recording and presenting audio/video programming for display to a user. As a result, circuitry normally associated with such devices may be present in the audio/video recording device 300, but is not explicitly illustrated in FIG. 3. For example, in the case of a satellite set-top box, the audio/video recording device 300 may include one or more tuners, as well as decoding and descrambling circuitry and other functional circuitry, in the audio/video programming interface 320. A detailed description of such circuitry is not described or depicted in FIG. 3 to simplify and facilitate the following discussion.

The audio/video recording device 300 is coupled with an output device 302, such as a television set, video monitor, audio receiver, or the other video and/or audio presentation device. While the output device 302 is displayed as being physically separate from the audio/video recording device 300, the two devices 300, 302 may be integrated as a single system, such as in a desktop or laptop computer system.

The audio/video programming interface 320, if included, is configured to receive audio/video programming. The design of the audio/video programming interface 320 is dependent at least in part on the environment in which the audio/video recording device 300 was designed to operate. For example, if the audio/video recording device 300 is a satellite set-top box, the audio/video programming interface 320 may include circuitry for receiving a satellite signal from an antenna, down-converting the signal, selecting a particular transponder frequency by way of a tuner 321, descrambling and/or decoding the data packets of the signal, selecting those data packets associated with a particular programming channel, and so on. If, instead, the audio/video recording device 300 is a DVR, the audio/video programming interface 320 may be designed to receive a single audio/video program at a time by way of a composite or component video connection, a cable connection, or other means without the aid of tuner circuitry. As a result, the audio/video programming interface 320 may receive audio/video programming from any of a number of sources, including, but not limited to, a satellite, a cable, a terrestrial source, and a computer network or other communication network.

In another embodiment, the audio/video recording device 300 may generate the audio/video programming internally. For example, the audio/video recording device 300 may include a video camera, microphone, and related circuitry to generate the audio and/or video constituting the programming.

In one implementation, the audio/video program 310 may incorporate one of the Motion Picture Experts Group (MPEG) standards for data encoding and compression, such as MPEG-2 or MPEG-4. Other data formatting or encoding methods, both analog and digital, may be employed in other embodiments.

The storage device 328 of FIG. 3 is configured to record audio/video programming. As such, the storage device 328 may include digital video recorder (DVR) circuitry in one embodiment. More specifically, the storage device 328 may include an audio/video storage unit, such as an optical or magnetic disk drive, along with circuitry useful for recording audio/video programming from the audio/video programming interface 320 or another source. Recording of the audio/video programming may be initiated manually by way of user interaction with the user interface 324, described more fully below, or by way of some more automatic means, such as a programmable timer capable of setting the day and time at which a recording of a program should be started and completed. The timer may be set by direct entry of the starting and ending times of the recording via the user interface 330, or by way of an electronic program guide (EPG) stored within the audio/video recording device 300. The circuitry associated with the storage device 328 also facilitates retrieving previously-recorded programs residing thereon for delivery to the output device 302 by way of the output interface 332.

The output interface 332 of the audio/video recording device 300 is configured to deliver audio/video programming, such as the audio/video program 310 of FIG. 3, to the output device 302 for display to a user. Typically, the output interface 332 is configured to reformat the audio/video program 310 so that the audio/video program 310 may be processed by the output device 302 for presentation to a user. For example, the audio/video program 310 may take the form of audio and video data suitable for transport over one or more of several audio/video connections, including, but not limited to, coaxial cable, composite video with separate audio channels, component video with separate audio channels, and the High-Definition Multimedia Interface (HDMI).

The communication interface 324 of the audio/video recording device 300 is configured to receive an indication 312 of an event not associated with the recording of audio/video programming. In other words, such an event is not related to the initiation of a recording of the audio/video program 310 or other programming, the setting of a recording timer, or other function associated with the recording of audio/video programs. For example, user initiation of a recording, either by way of directly starting a recording via a user panel of the audio/video recording device 300 or a remote control, or by way of setting a recording timer, would not be such an event.

Further, entities other than a user, such as a service provider of the audio/video programming or other external entity, or software or similar means within the audio/video recording device 300, may initiate a recording of one or more audio/video programs 310. These recordings may be based on a demographic group associated with the user, programs previously viewed by the user, viewing preferences cited by the user, or other data. The initiation of these recordings would also not be considered “events”, as the term is employed herein.

In one embodiment, the communication interface 324 receives indications 312 of events initiated externally to the audio/video recording device 300, but may ultimately involve the recording device 300. For example, the communication interface 324 may receive an indication 312, such as an electronic signal, of an incoming communication, such as a standard landline phone call, a cellular phone call, a videophone call, an e-mail message, a text message, and the like. In one instance, the communication may be directed toward the audio/video recording device 300, which may have the capability to engage in such communications by way of the communication interface 324. Alternately, the incoming communication constituting the event may be directed to another communication device not associated with the audio/video recording device 300, such as a landline phone, a cellular phone, a personal digital assistant (PDA), or a computer. In such cases, the communication device receiving the incoming communication may then provide the indication of the event to the audio/video recording device 300 through the communication interface 324. Alternately, the indication 312 may be generated internally within the audio/video recording device 300 in response to any of these incoming communications.

Other communications involving the audio/video recording device 300, but not specifically associated with the user of the device 300, may also constitute an event. For example, the indication 312 may be internally generated in response to an action of the service provider of the audio/video programming, including but not limited to an update of software or firmware resident within the recording device 300, a notice of upcoming programming of potential interest to the user, an emergency or warning message for the user, and the downloading of advertising or other content to the device 300. In some cases, these actions may require the attention of the user, and thus may qualify as events.

Similarly, the communication interface 324 may receive indications 312 of other events not specifically related to an incoming communication or the audio/video recording device 300, but events that nonetheless may require the attention of the viewer. One example of such an event would be a visitor activating a doorbell or similar device, thus announcing the presence of the visitor at the residence of the viewer. Other devices or appliances found within the home or office environment, such as computers, dishwashers, clothes washers and dryers, microwave oven, and the like, may issue an indication of an event associated with the particular device that involves viewer attention.

The communication interface 324 may include any type of wired or wireless interface capable of receiving the indication 312 of the event. Examples of wired interfaces include simple wired interfaces specifically designed for input of electronic signals, and the HomePlug® interface, which facilitates communication between two or more electronic devices over electrical power connections, such as the electrical utility wiring normally found in a home or business. Possible wireless interfaces include wireless fidelity (WiFi) connections, such as those supported by the Institute of Electrical and Electronics Engineers (IEEE), including IEEE 802.11a, 802.11b, 802.11g, and 802.11n. Another example of a wireless interface for the communication interface 324 may be the Bluetooth® short-range wireless communication protocol.

Within the audio/video recording device 300, communicatively coupled with each of the audio/video programming interface 320, the storage device 328, the communication interface 324, and the output interface 332, is a processor 326. In one embodiment, the processor 326 may be one or more microprocessors, microcontrollers, digital signal processors (DSPs), or any other processor configured to execute software instructions for performing the various tasks identified with the processor 326, such as coordinating the activities of the other components of the audio/video recording device 300, as well as the specific operations discussed in greater detail below. The software may be stored in a memory, such as the storage device 328 shown in FIG. 3, or a memory located internal to the processor 326. In another example, the processor 326 may be a collection of hardware logic circuitry to perform the functions described below, or a combination of software and hardware elements.

The user interface 330 depicted in FIG. 3 may be implemented as a user panel located on the audio/video recording device 300; a remote control interface adapted to receive commands electrically, optically, acoustically, or by other means from a remote control device (not shown in FIG. 3); or by any other form of user control over the audio/video recording device 300. While the user interface 330 commonly receives commands initiated from a user to control the various functions implemented in the audio/video recording device 300, the functionality of the user interface 330 as it pertains to the embodiments presented herein is described in greater detail below.

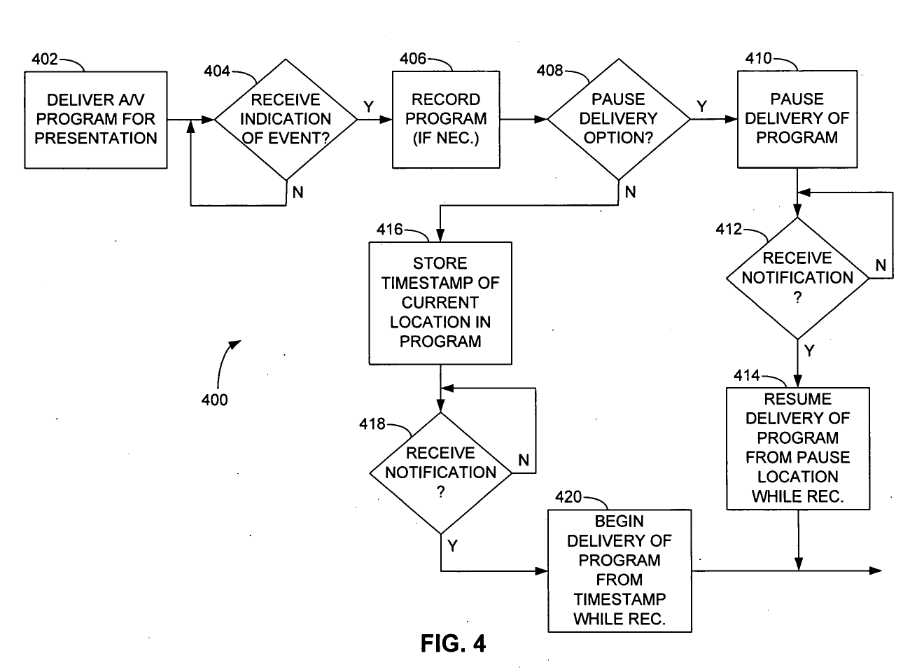

FIG. 4 provides a flow diagram of a method 400 of operating the audio/video recording device 300 according to an embodiment of the invention, although the method 400 may be implemented with devices other than those specifically depicted in FIG. 3. In the method 400, the output interface 332 delivers an audio/video program 310 to the output device 302 (operation 402). As mentioned earlier, the audio/video program 310 may be generated within the audio/video recording device 300, or received from an external source over the audio/video programming interface 320. With respect to the latter, the audio/video program 310 received at the programming interface 320 may be reformatted or otherwise modified before the output interface 332 delivers the program 310 to the output device 302. In another example, the audio/video program 310 being delivered to the output device 302 may be a program 310 previously recorded by, and currently sourced by, the storage device 328.

During delivery of the audio/video program 310, the communication interface 324 receives an indication 312 of an event (operation 404), as discussed above. In one implementation, the indication 312 includes information reflecting the source of the event. The processor 326, after receiving the indication 312 through the communication interface 324, causes the storage device 328 to record the program 310 if it has not already been recorded (operation 406). For example, if the audio/video program 310 is being received at the audio/video programming interface 320 and simultaneously being delivered to the output device 302 over the output interface 332 without being recorded, the processor 326, upon receiving the indication 312, signals the storage device 328 to begin recording the program 310. If the storage device 328 has already recorded the program 310, a second recording should not be necessary.

Upon receipt of the indication 312 of the event, the processor 326 also marks the current location of the audio/video program 310 currently being delivered over the output interface 332. At least two different ways of marking the current location are possible, as is seen in FIG. 4. Which implementation of marking the current location may be selected (operation 408) by way of design choice in the audio/video recording device 300, or by the viewer via a menu selection or similar means accessible via the user interface 330.

One way of marking the current location of the program 310 is by pausing the delivery of the program 310 through the output interface 332 (operation 410). Since the program 310 either has been recorded, or is currently being recorded, the remaining portion of the program 310 is saved for future viewing. The delivery of the audio/video program 310 will then remain paused until the processor receives a notification 314 (operation 412).

As depicted in FIG. 3, the notification 314 may be received by way of the communication interface 324 or the user interface 330. For example, the notification 314 may be an indication of the end of the event associated with the indication 312. For example, when a phone call event associated with the indication 312 ends, the phone involved may issue the notification 314 over the communication interface 324. In another instance, the viewer may issue the notification 314 by way of the user interface 330, such as a press of a button on a remote control. Further, viewer may configure the audio/video recording device 300 by way of the user interface 330 to select the communication interface 324, the user interface 330, or both as possible paths for receiving the notification 314.

In response to the processor 326 receiving the notification 314 through either the communication interface 324 or the user interface 330 (operation 412), the processor 326 causes the storage device 328 to resume delivery of the audio/video program 110 from its paused (marked) location (operation 414). As a result, from the beginning of the event (as denoted by the indication 312) until either the end of the event or at the request of the viewer (as signified by the notification 314), the audio/video program 310 being delivered will be paused so that the viewer, temporarily distracted by the occurrence of the event, will not miss any portion of the program 310 being presented to the viewer.

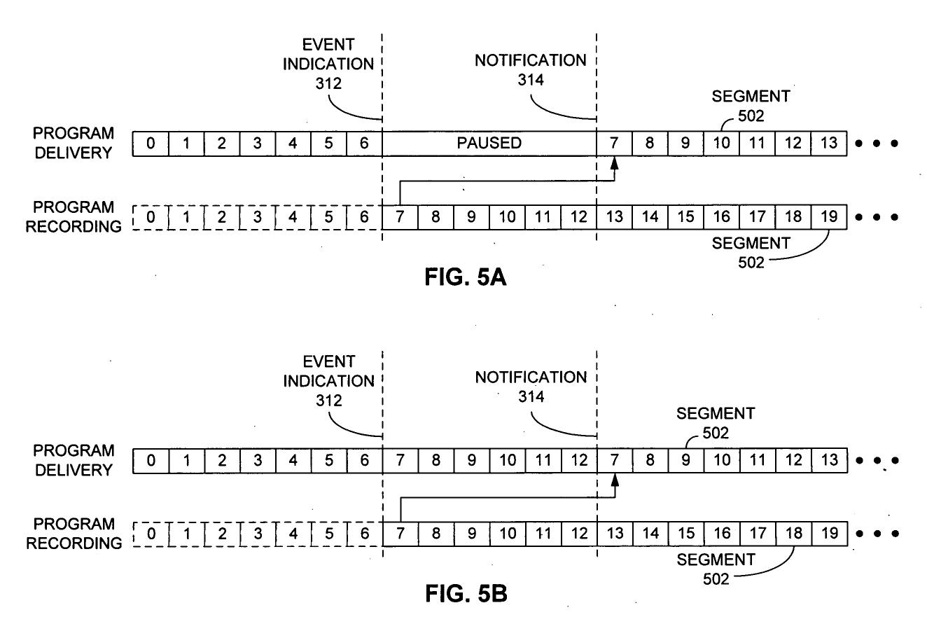

FIG. 5A illustrates the progression over time of the audio/video program 310 as it is being both delivered and recorded when delivery of the program 310 is paused. In both FIGS. 5A and 5B (discussed more fully below), the program 310 is represented as a series of audio/video segments 502 numbered consecutively from zero. The number listed for each of the segments 502 represents the relative order of the segments 502 in the audio/video program 310 merely to show the general progression over time of the program 310, and does not indicate a necessity to actually subdivide the program 310 into such segments 502.

FIG. 5A shows the program 310 being delivered through the output interface 332 beginning at the start of the program 310, and continuing uninterrupted until receipt of the indication 312 of an event. At that point, the storage device 328 records the program 310 beginning at least at that point (shown as segment 7 of the program 310). FIG. 5A also shows that the storage device 328 may have begun recording the program 310 prior to the event indication 312, such as in response to a recording timer set by a user of the audio/video recording device 300. At the event indication 312, delivery of the program 310 is paused (i.e., not progressing), during which time the storage device 328 has continued recording the audio/video program 310. Alternately, if the program 310 was recorded at a previous time, a second recording of the program 310 should not be necessary. The pausing of the delivery and the recording of the program 310 continue until the notification 314 is received via the user interface 330 or the communication interface 324, at which point the delivery of the audio/video program 310 is restarted at the point at which the program 310 was paused (segment 7). The storage device 328 continues to record the program 310, presumably up to the end of the program 310.

Under some circumstances, temporarily pausing the audio/video program 310 during the event may not be desirable. For example, several users may be viewing the audio/video program 310 together when an event occurs that requires the attention of only a single user. In that case, the remaining viewers may be available to continue watching the audio/video program 310. As a result, instead of pausing the program 310, the processor 326 may mark the current location in the program with a timestamp when the indication 312 of the event is received (operation 416). The timestamp 329 may be stored in the storage device 328, or in a separate storage device, for later retrieval. Thus, the audio/video program 310 continues to be delivered to the output interface 332 for presentation to the user at the output device 302 while the storage device 328 records the program 310, presuming the program 310 has not already been recorded.

Once the processor 326 receives the subsequent notification 314, the processor 326 causes the output interface 332 to reinitiate delivery of the audio/video program 310 beginning at the location in the program 310 denoted by the stored timestamp 329 while continuing to record the program 310, if previously unrecorded (operation 420).

FIG. 5B provides an illustration of this particular implementation. When the event indication 312 is received (at segment 7 of the program 310), the output interface 332 continues to deliver the program 310 without interruption, while the storage device 328 records the program 310 beginning at least at the receipt of the event indication 312. When the processor 326 then receives the notification 314 via the communication interface 324 or the user interface 330, the processor 326 begins delivering the audio/video program 310 at the location indicated by the timestamp 329 (segment 7) while the storage device 328 continues to record the program 310, if the storage device 328 has not already done so.

While each of the examples discussed above indicate that the marked location, by way of pause or timestamp, is employed as the beginning delivery location of the program 310 in response to the notification 314, other possibilities exist. More specifically, delivery of the program 310 may begin shortly before or thereafter, depending on the implementation. In one particular example, once the notification 314 has been received, the processor 326 may begin delivery or playback of the audio/video program 310 at some predetermined length of time, such as one minute, prior to the paused or timestamped location to provide a reminder to the user as to the previously-viewed content of the program 310 prior to displaying the unviewed portion. In addition, the amount of time between the restarting point and the paused or timestamped location in the program 310 may be selected by the user through the user interface 330 by way of menu selection or other methods.

After the receipt of the event indication 312, the processor 326 may cause the output interface 332 to display a visual indication or message, such as a pop-up display or an icon, on the output device 302 to indicate that an event requiring the attention of the viewer has occurred. Further, presuming the processor 326 is capable of distinguishing the source of the event (e.g., a phone call, as opposed to an e-mail message), the pop-up display or icon may indicate the source of the event to allow the viewer to appropriately address or process the event. Further, the processor 326 may cause the output interface 332 to remove the pop-up or icon after a predetermined period of time, or the processor 326 may remove the visual indication of the event once the notification 314 is received. In another embodiment, an audio message or indication presented by the output interface 332 to the output device 302 may be utilized in lieu of, or in addition to, the visual message.

In some embodiments, especially when the delivery of the audio/video program 310 through the output interface 332 is paused during the event of interest, the storage device 328 may record the program 310 to a temporary buffer separate from other programs that have been specifically and intentionally recorded at the request of the viewer. However, such temporary buffer storage space may be limited, thus possibly preventing the recording of the program 310 during the entirety of the time period between receipt of the event indication 312 and receipt of the notification 314. To address this potential problem, the storage device 328 may be configured to continue recording beyond this limitation, either by expanding the allowable amount of temporary buffer space, or recording the audio/video program 310 to a larger, more permanent area of the storage device 328 being employed to record the program 310. Such functionality may allow the remainder of the program 310 after the receipt of the event indication 312 to be recorded.

Various embodiments as described herein may provide a number of benefits. An audio and/or video program currently being enjoyed by a viewer may be automatically recorded upon an indication of an event, such as an incoming phone call or message, or a personal visitor ringing a doorbell, without any action of the viewer. Also, at the time of the event, the presentation of the program may be paused, or the current location of the program may be timestamped or otherwise marked, so that upon a termination of the event, or at the request of the user, the viewing of the program may be restarted beginning at or near the point at which the interruption first occurred. As a result, events requiring the immediate attention of the viewer need not result any portion of the program of interest being missed, thereby reducing the potential for viewer frustration.

While several embodiments of the invention have been discussed herein, other embodiments encompassed by the scope of the invention are possible. For example, while various embodiments have been described primarily within the context of satellite set-top boxes, any other device that records and presents audio/video programming for viewing, such as cable and terrestrial set-top boxes; satellite, cable, and terrestrial radio receivers; DVRs; and various computer systems, may benefit from application of the various concepts described herein. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method of operating an audio/video recording device, the method comprising:
delivering an audio/video program to an output device for display;
receiving an indication of an event not associated with a recording function of the audio/video recording device during delivery of the audio/video program;
in response to receiving the indication, marking a current location in the audio/video program in the audio/video recording device, and recording the audio/video program if not already recorded; and
delivering the recording of the audio/video program to the output device beginning at the marked location in the audio/video program.

2. The method of claim 1, further comprising:
receiving a notification after receiving the indication;
wherein delivering the recording of the audio/video program beginning at the marked location is performed in response to receiving the notification.

3. The method of claim 2, wherein receiving the notification comprises receiving a signal indicating that the event has ended.

4. The method of claim 2, wherein receiving the notification comprises receiving an indication from a user.

5. The method of claim 1, wherein:
marking the current location in the audio/video program comprises storing a timestamp of the current location of the audio/video program while continuing to deliver the audio/video program to the output device.

6. The method of claim 1, wherein:
marking the current location in the audio/video program comprises pausing the delivery of the audio/video program to the output device; and
the marked location comprises a location at which the audio/video program is paused.

7. The method of claim 1, wherein recording the audio/video program further comprises:
continuing to record the audio/video program in excess of a storage limit of a temporary recording buffer in the audio/video recording device.

8. The method of claim 1, further comprising:
presenting a message to the output device to notify a user of the event.

9. The method of claim 1, further comprising:
receiving the audio/video program into the audio/video recording device.

10. The method of claim 1, wherein the event comprises an incoming communication.

11. The method of claim 10, wherein the incoming communication comprises one of an audio phone call, a video phone call, an e-mail message, and a text message.

12. The method of claim 1, wherein the event is initiated by a service provider of the audio/video program.

13. The method of claim 1, wherein the event is initiated within the audio/video recording device.

14. A computer-readable medium having encoded thereon instructions executable by a processor of an audio/video recording device to direct the audio/video recording device to perform a method comprising:
delivering an audio/video program for presentation to a user;
receiving an indication of an event not associated with a recording function of the audio/video recording device during delivery of the audio/video program;
in response to receiving the indication, noting a current location in the audio/video program in the audio/video recording device and recording the audio/video program if not already recorded; and
delivering the recording of the audio/video program for presentation to the user beginning at the noted location in the audio/video program.

15. An audio/video recording device, comprising:
an output interface configured to deliver audio/video programming to an output device for display;
a storage device configured to record one or more programs of the audio/video programming;
a communication interface configured to receive an indication of an event not associated with the storage device, wherein the indication of the event occurs while the output interface delivers an audio/video program to the output device; and
a processor configured to:
receive the indication from the communication interface;
in response to the indication, mark a current location in the audio/video program being delivered over the output interface to the output device and cause the storage device to record the audio/video program if not already recorded; and
deliver the recording of the audio/video program over the output interface beginning no later than at the marked location in the audio/video program.

16. The audio/video recording device of claim 15, wherein the processor is further configured to:
receive a notification from the communication interface, wherein the notification is received after the indication is received;
wherein the processor is configured to deliver the recording of the audio/video program beginning no later than at the marked location in response to receiving the notification.

17. The audio/video recording device of claim 16, wherein:
the storage device is configured to store a timestamp of the current location in the audio/video program; and
the processor is configured to mark the current location by storing the timestamp to the storage device, and, in response to receiving the notification, initiate delivery of the audio/video program through the output interface to the output device no later than at the timestamp.

18. The audio/video recording device of claim 16, wherein:
the processor is configured to mark the current location by pausing the delivery of the audio/video program, and, in response to the notification, deliver the recording of the audio/video program over the output interface to the output device by restarting the delivery of the audio/video program no later than from the location of the pause in the audio/video program.

19. The audio/video recording device of claim 16, wherein:
the processor is configured to continue to cause the storage device to record the audio/video program until at least the end of the audio/video program prior to receiving the notification.

20. The audio/video recording device of claim 16, wherein:
the communication interface is configured to receive the notification by receiving a signal indicative of the notification, wherein the signal is originated externally to the audio/video recording device.

21. The audio/video recording device of claim 16, further comprising:
a user interface configured to receive a signal indicative of the notification, wherein the signal is initiated by a user.

22. The audio/video recording device of claim 15, further comprising:
an audio/video programming interface configured to receive the audio/video programming.

23. The audio/video recording device of claim 22, wherein:
the audio/video programming interface comprises a tuner configured to select a channel of the audio/video programming to be delivered over the output interface to the output device.
